(19) United States
(12) Patent Application Publication
(10) Pub. No.: US 2020/0167931 A1
(43) Pub. Date: May 28, 2020

(54) CONTROLLING COMPONENTS OF AN ENERGY INDUSTRY OPERATION USING A PROCESSING SYSTEM

(71) Applicants: Xiaoqing Ge, Edmond, OK (US); Dustin Sharber, Oklahoma City, OK (US); Jeffrey Robert Potts, Oklahoma City, OK (US); John Westerheide, Edmond, OK (US); Jeremy Daniel Van Dam, Edmond, OK (US)

(72) Inventors: Xiaoqing Ge, Edmond, OK (US); Dustin Sharber, Oklahoma City, OK (US); Jeffrey Robert Potts, Oklahoma City, OK (US); John Westerheide, Edmond, OK (US); Jeremy Daniel Van Dam, Edmond, OK (US)

(73) Assignee: Baker Hughes, a GE company, LLC, Houston, TX (US)

(21) Appl. No.: 16/675,794

(22) Filed: Nov. 6, 2019

Related U.S. Application Data
(60) Provisional application No. 62/771,446, filed on Nov. 26, 2018.

(51) Int. Cl. G06T 7/12; E21B 47/00; G06T 15/00; G06T 7/00; F16P 3/14; G06F 3/01

(52) U.S. Cl. CPC G06T 7/12; E21B 47/0002; G06T 15/005; G06T 2207/30181; F16P 3/142; G06F 3/011; G06T 7/0004

(57) ABSTRACT

A system including an energy industry operation component and a processing system associated with the energy industry operation component is provided. The processing system includes an accelerator and is configured to perform at least one of image segmentation and vision analysis for authenticated lockout, image segmentation and vision analysis for performance audit, or augmented reality rendering and streaming.

### CROSS-REFERENCE TO RELATED APPLICATION

This application claims the benefit of U.S. Patent Application No. 62/771,446, filed Nov. 26, 2018, the entire disclosure of which is incorporated herein by reference.

### BACKGROUND

The present disclosure relates generally to wellbore operations and more particularly to controlling components of an energy industry operation using a processing system.

Energy industry operations such as hydrocarbon exploration employ various systems and operations to accomplish activities including drilling, formation evaluation, stimulation, and production. Various techniques may be employed to facilitate hydrocarbon exploration and production activities.

### BRIEF SUMMARY

Embodiments of the invention described herein provide systems, methods, and computer program products for controlling components of an energy industry operation using a processing system.

In one embodiment, a system includes an energy industry operation component; and a processing system associated with the energy industry operation component, the processing system comprising an accelerator and being configured to perform at least one of image segmentation and vision analysis for authenticated lockout, image segmentation and vision analysis for performance audit, or augmented reality rendering and streaming.

In another embodiment, a method includes receiving, by a processing system comprising an accelerator, an image from a camera, the camera capturing the image at an energy industry operation site; performing, by the processing system, image segmentation and vision analysis for authenticated lockout based at least in part on the image; determining, by the processing system, whether an authentication lockout criterion is satisfied; and, responsive to determining that the authentication lockout criterion is not satisfied, implementing, by the processing system, a lockout procedure on an energy industry operation component at the energy industry operation site.

In yet another embodiment, a method includes receiving, by a processing system comprising an accelerator, an image from a camera, the camera capturing the image at an energy industry operation site; performing, by the processing system, image segmentation and vision analysis for authenticated performance audit based at least in part on the image to associate a time stamp with a service performed at the energy industry operation site; determining, by the processing system, whether the time stamp associated with the service corresponds to performance data; and, responsive to determining that the time stamp associated with the service does not correspond to the performance data, implementing, by the processing system, a corrective action to correct the performance data.

Further, in another embodiment, a method includes storing an augmented reality package in a memory of a processing system associated with an energy industry operation component at an energy industry operation site, the processing system comprising an accelerator; receiving, by the processing system, a request for the augmented reality package from a user device associated with a user; rendering, by accelerator of the processing system, the augmented reality package; and streaming, by the processing system, the rendered augmented reality package to the user device associated with the user.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages thereof, are apparent from the following detailed description taken in conjunction with the accompanying drawings in which:

FIG. 1 depicts an edge processing system disposed in an energy industry operation component according to one or more embodiments described herein;

FIG. 2 depicts the edge processing system of FIG. 1 associated with energy industry operation components according to one or more embodiments described herein;

FIG. 3 depicts a block diagram of the edge processing system of FIG. 1 according to one or more embodiments described herein;

FIG. 4 depicts a flow diagram of a method for image segmentation and vision analysis for authenticated lockout according to one or more embodiments described herein;

FIG. 5 depicts a flow diagram of a method for image segmentation and vision analysis for performance audit according to one or more embodiments described herein;

FIG. 6 depicts a flow diagram of a method for augmented reality rendering and streaming from an edge processing system according to one or more embodiments described herein; and

FIG. 7 depicts a block diagram of a processing system for implementing the techniques described herein according to aspects of the present disclosure.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

### DETAILED DESCRIPTION

A detailed description of one or more embodiments of the disclosed system, apparatus, and method presented herein by way of exemplification and not limitation with reference to the figures. Disclosed are techniques for controlling components of an energy industry operation using a processing system, such as an edge processing system.

An edge processing system performs processing tasks locally rather than offloading the processing tasks to a remote resource, such as a de-centralized cloud environment. Many tasks that utilize significant processing resources, such as image segmentation and vision analysis, augmented reality rendering and streaming, natural language processing (NLP), and the like, utilize de-centralized cloud environments or other de-centralized processing resources rather than local resources. However, the remote de-centralized approach introduces latency as a result of transmitting data between a local processing system and a remote (cloud) processing system and utilizes large amounts of bandwidth.

In many energy industry operations, it may not be possible or feasible to rely on cloud computing environments to perform these processing resource intensive tasks because of the latency and bandwidth concerns. For example, an energy industry operation operating in a rural, remote geographic location might not have any data communication connection or might rely on satellite-based data communication connection. However, satellite-based data communication can be costly (e.g., a satellite provider may charge on a per-byte basis) and can introduce latency. It is therefore desirable to perform processing- intensive tasks, such as image segmentation and vision analysis, augmented reality rendering and streaming, natural language processing (NLP), locally to the energy industry operation.

Accordingly, the present techniques utilize a processing system having an accelerator to perform processing tasks locally at the energy industry operation, thereby reducing data communication requirements and latency concerns. Accordingly, the processing system provided herein represents an improvement to energy industry operations and traditional processing systems by performing processing tasks locally using the accelerator at the energy industry operation rather than remotely.

The descriptions provided herein are applicable to various oil and gas or energy industry data activities or operations. Although embodiments herein are described in the context of drilling, completion and stimulation operations, they are not so limited. The embodiments may be applied to any energy industry operation. Examples of energy industry operations include surface or subsurface measurement and modeling, reservoir characterization and modeling, formation evaluation (e.g., pore pressure, lithology, fracture identification, etc.), stimulation (e.g., hydraulic fracturing, acid stimulation), coiled tubing operations, drilling, completion and production.

One or more embodiments described herein leverage advancements in low-power accelerators, such as a graphics processing units (GPU) or another suitable accelerator, to enable processing systems to create an interactive wellsite surveillance, authentication, and optimization platform. Processing systems as described herein, such as edge processing systems, can be installed on virtually any wellsite equipment but would preferentially be installed or retrofitted into a variable speed drive (VSD) or other energy industry operation component (e.g., a heater-treater, a value, a pump, etc.) to provide power and a protective enclosure. In one or more embodiments, the processing system described herein can be implemented as a stand-alone component at an energy industry operation and associated with other energy industry operation components.

According to one or more embodiments of the processing system described herein, a GPU architecture or other accelerator can be used to perform real-time inferencing of a live camera feed(s) on the energy industry operation, allowing the processing system to identify personnel and activities being performed on location. Additionally, the accelerator-based (e.g., GPU-based) processing system can function as an augmented reality server and process voice instructions using NLP, such as for personnel who have been authenticated by facial recognition. By bringing these advanced computing capabilities into the field, processing systems described herein provide significant technical improvement and increased value to oil and gas operators through reduced health, safety, and environmental (HSE) risk, increased personnel efficiency, reduced latency in image processing and augmented reality (AR) rendering and streaming, reduced bandwidth requirements for transmitting data for remote processing, and the like. As used herein, AR refers to graphical information superimposed on a physical environment of the user, sometimes referred to as “mixed reality.”

GPUs offer significant computing power in a small form factor, allowing for a broad range of functionality including performing image recognition/computer vision, natural language processing and artificial intelligence, AR, and data analysis at the processing system.

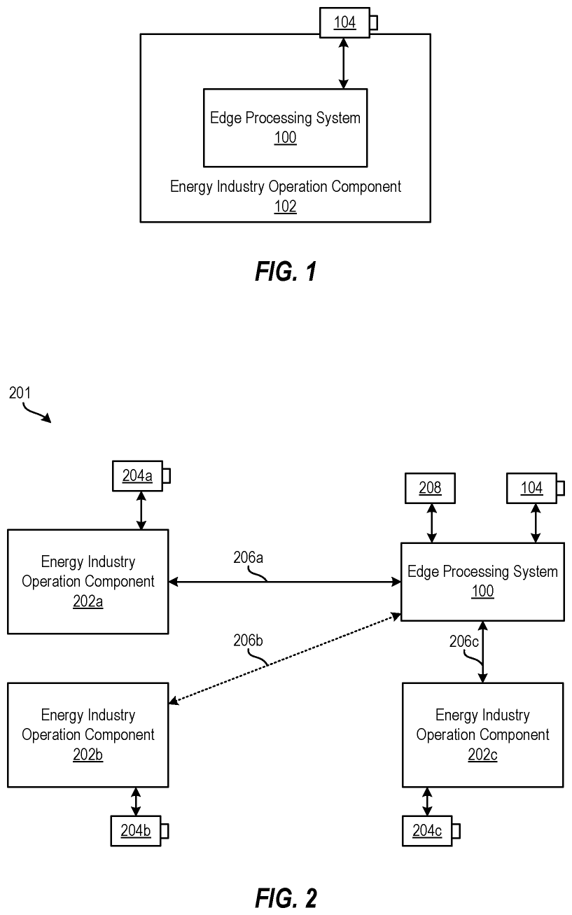

FIG. 1 depicts an edge processing system 100 disposed in an energy industry operation component 102 according to one or more embodiments described herein. The energy industry operation component 102 can include a VSD, a heater-treater, a valve, a pump, combinations thereof, and the like. The energy industry operation component 102 can provide power and a protective enclosure for the edge processing system 100.

The edge processing system 100 is configured to receive an image from a camera 104. For example, the camera 104 can be in wired and/or wireless communication with the edge processing system 100. The camera, for example, captures an image (or images) at the energy industry operation including of personnel, equipment/components/devices, vehicles, and the like. The image(s) can be used to perform an image segmentation and vision analysis that can be used for authenticated lockout and/or performance audit.

Also referred to as computer vision, image segmentation and vision analysis provides real-time inferencing at the energy industry operation. The image segmentation and vision analysis can process images received from cameras around the energy industry operation to authenticate users, verify user certifications, verify proper personal protective equipment (PPE) usage, and the like. In some examples, computer vision models can be trained locally at the edge processing system 100 rather than remotely.

According to one or more embodiments described herein, cameras (e.g., the camera 104) powered by the VSD (e.g., the energy industry operation component 102) and connected to the edge processing system 100 scan the energy industry operation environment to track and monitor people, equipment, vehicles, components, and the like. When an object (e.g., person, truck, wildlife, etc.) is detected the camera 104 begins capturing and saving images. Using these images, the edge processing system 100 performs image segmentation and vision analysis, which includes, for example, drawing a bounding box around object(s) of interest in the images and categorizing the type of the detected object(s) of interest along with the position of the object relative to other objects proximal to the energy industry operation site. If internet and/or other network connectivity is available, a notification can be sent to designated personnel offsite. Image models of authorized personnel can be uploaded onto the edge processing system 100 (remotely with an active connection and/or locally) and used to recognize individuals who visit the site (e.g., pumpers, servicers, etc.). When an individual is recognized, a database query can be made to ensure that the individual is up-to-date on necessary certifications and training. Additionally, the edge processing system 100 can validate proper PPE usage for each person on site using the image segmentation and vision analysis. Additionally, the edge processing system 100 can associate time stamps of services being performed at the energy industry operation, such as water hauling or chemical treatments. These timestamps can be used for performance auditing to verify proper invoicing by service companies, for example.

According to one or more embodiments described herein, the edge processing system 100 is also configured to perform AR rendering and streaming. For example, once a user is authenticated using computer vision techniques described herein, the edge processing system 100 can be used to render content for AR applications running on a user device, such as a smartphone, tablet, or wearable computing device (e.g., smartglasses, an AR headset, etc.). U.S. Patent Publication No. 2016/0378185, filed on Jun. 23, 2016, and entitled “INTEGRATION OF HEADS UP DISPLAY WITH DATA PROCESSING” describes a wearable information gathering and processing system.

According to one or more embodiments, the AR rendering and streaming can stream technical drawings to the user's device to aid the user in visualizing a component, compare as-designed drawings to as-built equipment, etc. Additionally, AR applications can be used to display real-time sensor data coming from instrumented components on the energy industry operation, such as wellhead pressure and temperature data, tank level data, etc., thus serving as a unified human-machine interface for multiple components on site. Content to be streamed can be stored on a memory or other data storage device, such as a solid state disk or other similar data storage drive, attached to or otherwise associated with the edge processing system 100. This allows for a library of assets and procedures to be stored locally at the energy industry operation without the need for an active internet or network connection. The edge processing system 100 can serve as a local wireless access point to stream content to authenticated users in the vicinity (e.g., at the energy industry operation). Therefore, because the rendering capability of the edge processing system 100 generally far exceeds that of consumer mobile devices, richer and more complex content can be visualized in the field by rendering the AR content on the edge processing system 100 and streaming it to a user's mobile device.

According to one or more embodiments described herein, the edge processing system 100 is also configured to perform natural language processing (NLP). For example, the edge processing system 100 can be used for recognition of keywords/phrases to perform certain tasks on site. For example, a technician wanting to launch an AR application for a maintenance procedure could do so by voice instruction to the edge processing system 100. Additionally, the edge processing system 100 could use NLP technology to respond to/confirm commands, provide instructions, alerts, and reminders to field personnel. For example, a technician could issue a voice command to change an aspect or parameter of the energy industry operation equipment (e.g., “Increase the frequency of the VSD by 2 hertz.”).

According to one or more embodiments described herein, depending on reliability, cost, speed, etc., of a data connection between the edge processing system 100 and a remote processing resource (e.g., a cloud computing environment or other remote processing system (not shown)), the edge processing system 100 can perform some of the computing vision, AR rendering and streaming, and NLP tasks locally and offload other of the tasks to the remote processing resource. The edge processing system 100 can decide which tasks to perform locally and which to offload based on performance demands, priority of the tasks, and the like. For example, at particularly busy times, the edge processing system 100 may offload lower priority tasks (e.g., NLP tasks) to a remote processing resource while performing higher priority tasks (e.g., computer vision tasks).

In some examples, the edge processing system 100 can receive updates to computing vision algorithms, AR applications, NLP libraries, user databases (such as for authorization, training, certification, PPE information, etc.) and the like. Such updates can be received locally, such as from a flash drive or other memory device and/or remotely over a network connection.

FIG. 2 depicts the edge processing system 100 of FIG. 1 associated with energy industry operation components 202a, 202b, 202c according to one or more embodiments described herein.

In this example, the edge processing system 100 is a separate component from the energy industry operation component 202a, 202b, 202c but is communicatively coupled to one or more of the energy industry operation component 202a, 202b, 202c. For example, the edge processing system 100 is communicatively coupled to the energy industry operation components 202a and 202c by wired communication links 206a and 206c respectively. Similarly, the edge processing system 100 is communicatively coupled to the energy industry operation component 202b by a wireless communication link 206b. Similarly, the edge processing system 100 is communicatively coupleable to a user device 208 (e.g., a smartphone, a laptop, a tablet, a wearable computing device such as a smartwatch or headset, etc.), which is associated with a user (not shown).

The energy industry operation components 202a, 202b, 202c can be any suitable component, device, or equipment associated with an energy industry operation, such as a VSD, a heater-treater, a pump, etc. Each energy industry operation component 202a, 202b, 202c can have a camera (or multiple cameras) associated therewith, including cameras 204a, 204b, 204c respectively. In this way, the edge processing system 100 can receive images from the multiple cameras (e.g., the cameras 104 and 204a-204c) from around the site 201.

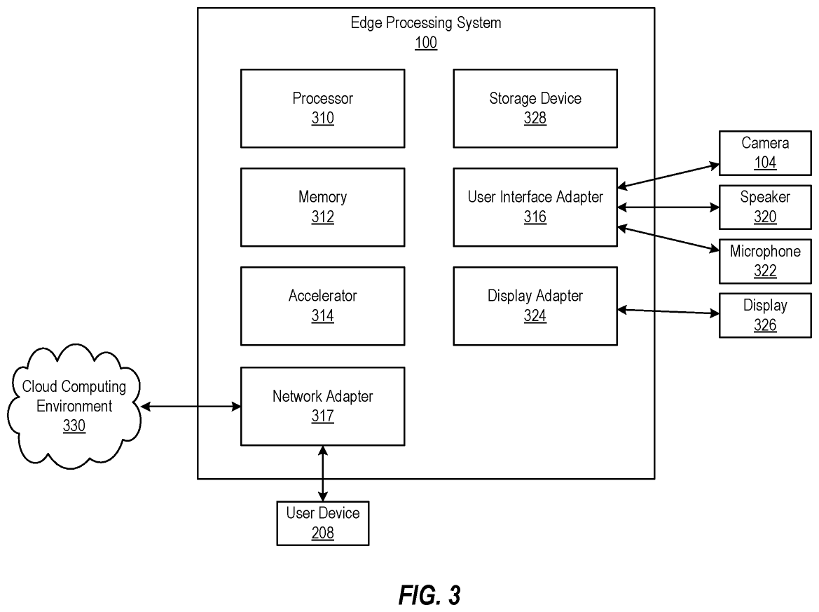

FIG. 3 depicts a block diagram of the edge processing system 100 of FIG. 1 according to one or more embodiments described herein. The edge processing system 100 may include a processor 310 (e.g., a microprocessor, a central processing unit, etc.), a memory 312, an accelerator 314 (e.g., a graphics processing unit (GPU)), a network adapter 317, a storage device 328 (e.g., a solid state drive, a hard disk drive, a flash memory, a non-volatile memory, etc.), a user adapter interface 316, and a display adapter 324.

The network adapter 317 can communicatively couple to other devices, such as a cloud computing environment 330, the user device 208, etc. via one or more wired and/or wireless network(s). The user interface adapter 316 is configured to transmit data to and receive data from various devices, such as the camera 104, the cameras 204a-204c, a speaker 320, a microphone 322, and the like. The display adapter 324 transmits image data to a display 326.

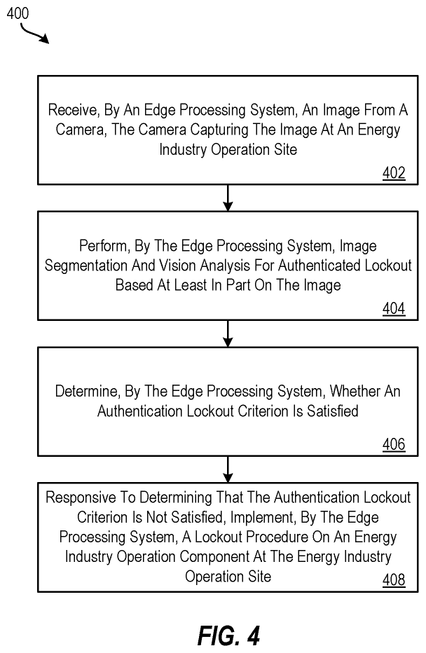

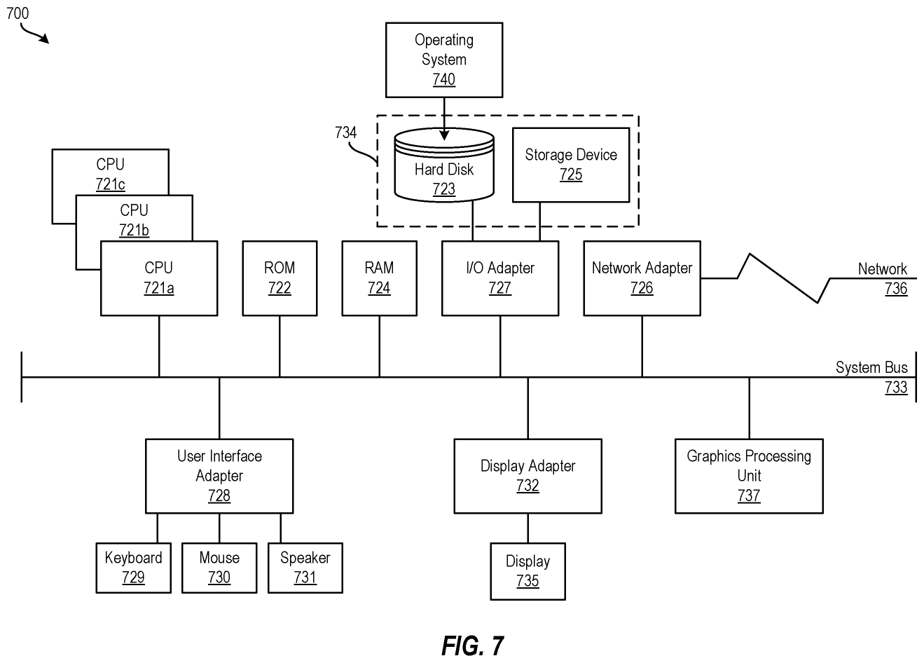

The functionality of the edge processing system 100 and its components are now described with reference to FIGS. 4, 5, and 6. In particular, FIG. 4 depicts a flow diagram of a method for image segmentation and vision analysis for authenticated lockout according to one or more embodiments described herein. The method 400 can be performed by any suitable processing system and/or processing device, such as the edge processing system 100 of FIGS. 1-3 and/or the processing system 700 of FIG. 7.

At block 402, the edge processing system 100, comprising the accelerator 314, receives an image from the camera 104 (or another camera) or from multiple cameras (e.g., cameras 204a-204c). The camera 104 captures the image at the energy industry operation site 201.

At block 404, the edge processing system 100 performs image segmentation and vision analysis for authenticated lockout based at least in part on the image received from the camera 104. Image segmentation partitions a digital image into segments, which are sets of pixels, in order to simplify an image so that it is easier to analyze. Image segmentation enables objects and boundaries to be detected/determined. In this way, image segmentation and vision analysis can identify features in images, such as faces, vehicles, equipment, actions, objects, and the like.

At block 406, the edge processing system 100 determines whether an authentication lockout criterion is satisfied. Examples of authentication lockout criteria include whether a user is an authorized user (determined by performing facial recognition on an image of the user and comparing against an authorized user database), whether the user is properly trained/certified (determined by performing facial recognition on an image of the user and comparing against a training/certification database), whether the user is properly equipped with PPE (determined by performing object recognition on an image of the user to detect PPE, such as a hard hat, safety glasses, steel-toed boots, etc., and comparing the identified PPE against a database of required PPE for the energy industry operation site), whether a require minimum of individuals are present (e.g., determine whether at least two trained and certified technicians are present for a job that requires two such technicians), determine whether an unauthorized device is being used (e.g., a cheater bar), whether the user is performing an unsafe act (e.g., determine whether the user is using a tool improperly, changing a setting on a component to an unsafe level, attempting to access a component that the user is not authorized to access), and the like. In some examples, a lockout criterion is that the energy industry operation component is in a high energy state. For example, if the VSD is energized with a high voltage power source, it may remain locked out to a user even if the user is authorized, trained, certified, and the like, in order to protect the user and prevent the user from accessing the VSD while it is in the high energy state.

At block 408, if it is determined that the authentication lockout criterion is not satisfied, a lockout procedure is implemented on an energy industry operation component at the energy industry operation site. The lockout procedure can include activating a physical lock on the energy industry operation component 102 (or other equipment), preventing a physical lock on the energy industry operation component 102 (or other equipment) from being unlocked, restricting what access the user has (e.g., if a user is not certified to access the VSD but is certified to operate a pump, preventing access to the VSD but authorizing access to the pump), etc. That is, if at block 406 it is determined that the authentication lockout criterion is satisfied, then the edge processing system 100 grants access to an energy industry operation component at the energy industry operation site.

Additional processes also may be included, and it should be understood that the process depicted in FIG. 4 represents an illustration, and that other processes may be added or existing processes may be removed, modified, or rearranged without departing from the scope and spirit of the present disclosure.

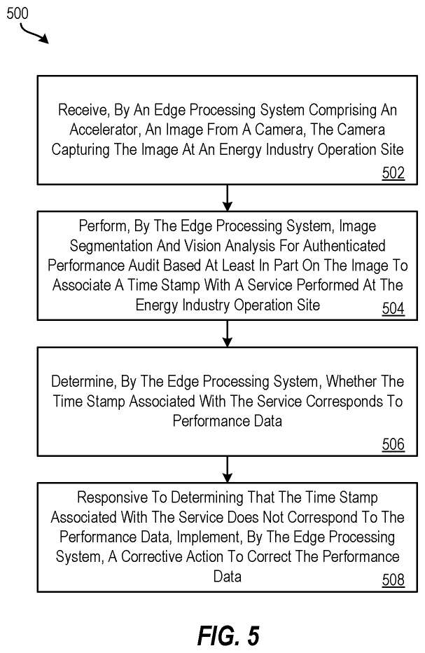

Turning now to FIG. 5, this figure depicts a flow diagram of a method for image segmentation and vision analysis for performance audit according to one or more embodiments described herein. The method 500 can be performed by any suitable processing system and/or processing device, such as the edge processing system 100 of FIGS. 1-3 and/or the processing system 700 of FIG. 7.

At block 502, the edge processing system 100, comprising the accelerator 314, receives an image from the camera 104 (or another camera). The camera 104 captures the image at the energy industry operation site 201.

At block 504, the edge processing system 100 performs image segmentation and vision analysis for authenticated performance audit based at least in part on the image to associate a time stamp with a service performed at the energy industry operation site. For example, the edge processing system 100 analyses an image or images to detect when a service technician arrives on site and when the technician departs from the site. The edge processing system 100 can associate time stamps with the arrival and departure to determine how long the technician is at the site 201.

At block 506, the edge processing system 100 determines whether the time stamp(s) associated with the service (e.g., how long the technician is at the site 201) corresponds to performance data. The performance data can be, for example, an employee's recorded service hours, invoice data, and the like.

At block 508, if it is determined at block 506 that the time stamp associated with the service does not correspond to the performance data, the edge processing system 100 can implement a corrective action to correct the performance data. For example, the edge processing system 100 can adjust (or cause to be adjusted) an invoice to correct any discrepancy between the performance data of the invoice against actual service time that the technician was at the site 201. The present techniques can also account for breaks or other non-working time that the technician is at the site 201 but not performing a service that is indicated in the performance data. Similarly, the present techniques can detect a service that is performed but not reflected in the performance data. For example, an invoice can be corrected to include a service that was actually performed but not recorded on the invoice (i.e., performance data).

In some examples, the edge processing system 100 can track a servicer and a vehicle associated with the servicer separately. For example, the edge processing system can determine when the vehicle arrives to and departs from the site 201. The edge processing system 100 can identify a vehicle, for example, by an indicium on the vehicle such as a logo/sign, a license plate, a barcode, a radio frequency identifier (RFID) tag, a QR code, or another indicator. Similarly, the edge processing system 100 can track a servicer around the site 201 by tracking an indicium associated with the servicer, by using facial recognition of the servicer, etc. In this way, the edge processing system 100 can segment both temporally and spatially.

As one such example implementation of the method 500, a schedule of wellsite operations for a particular month (i.e., December) is uploaded to the edge processing system 100, either remotely or locally. This includes the planned inspection of holding tank levels and heater-treater state by authorized servicers (i.e., “pumpers”). Then, when a pumper shows up and the activities of that pumper are identified by the edge processing system 100 during the pumper's visit, discrepancies can be identified. If the pumper fails to show up at the site 201 or fails to check tank levels (e.g., the pumper is identified as staying in his vehicle the entire time of his visit and is not observed as leaving his vehicle or checking tank levels), these events can be logged, and the consequences of these events (e.g., spilling tanks, failing heater-treaters, unplanned artificial lift shutdowns, explosions, etc.) can be reduced or eliminated.

Additional processes also may be included, and it should be understood that the process depicted in FIG. 5 represents an illustration, and that other processes may be added or existing processes may be removed, modified, or rearranged without departing from the scope and spirit of the present disclosure.

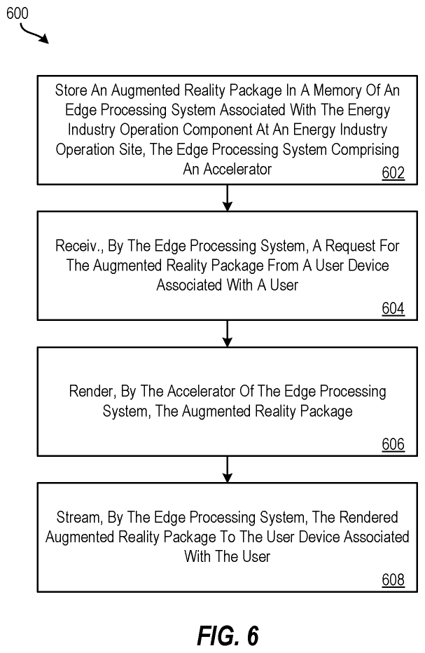

Turning now to FIG. 6, this figure depicts a flow diagram of a method for augmented reality rendering and streaming from an edge processing system according to one or more embodiments described herein. The method 600 can be performed by any suitable processing system and/or processing device, such as the edge processing system 100 of FIGS. 1-3 and/or the processing system 700 of FIG. 7.

At block 602, an augmented reality package is stored in the memory 312 of the edge processing system 100 associated with the energy industry operation component 102 at the energy industry operation site 201. The augmented reality package can include as-designed drawings/diagrams, as-built drawings/diagrams, exploded views of components/equipment, and the like.

At block 604, the edge processing system 100 receives a request for the augmented reality package from a user device 208 associated with a user. According to one or more embodiments described herein, the user is located at the energy industry operation site 201, such as within a wireless networking range of the edge processing system 100.

At block 606, the edge processing system 100, utilizing the accelerator 314, renders the augmented reality package.

At block 608, the edge processing system 100 streams the rendered augmented reality package to the user device 208 associated with the user. For example, the rendered augmented reality package can be presented to the user on the user device 208, which can include a display for viewing the augmented reality package. The user device 208 can include a smartphone, a laptop, a tablet, a wearable computing device such as a smartwatch or a headset, and the like.

The edge processing system 100 can also stream the rendered augmented reality package to a remote user to enable the remote user and the user (who is considered a local, with respect to the edge processing system 100, user). In this way, the local user and the remote user can view the augmented reality package concurrently, which can improve troubleshooting and maintenance. For example, a remote expert can guide a local technician to troubleshoot and perform maintenance on the energy industry operation component 102 (or another component or device).

Additional processes also may be included, and it should be understood that the process depicted in FIG. 6 represents an illustration, and that other processes may be added or existing processes may be removed, modified, or rearranged without departing from the scope and spirit of the present disclosure.

Advantages of the presently described techniques are numerous. For example, the present techniques leverage computer vision technology to reduce HSE risk. The edge processing system 100 can recognize personnel on location (and generate alerts for trespassers) and ensure that each identified person is properly trained/certified. Identified personnel can also be screened for proper PPE, including hard hats and safety glasses, to verify personnel are using the proper controls and catch any habitual policy offenders.

Another advantage of the presently described techniques is that the edge processing system 100 can optimize and improve the performance of energy industry operations. For example, the edge processing system 100 can synthesize data from a VSD and other sensors (e.g., pressure, temperature, etc.) at the energy industry operation. Further, the edge processing system 100 can run analytics and/or prognostics based on collected data and potentially adjust parameters in real-time, serving as a “nerve center” of the energy industry operation.

Yet another advantage of the presently described techniques is that the edge processing system 100 can create and improve personnel efficiency with localized AR rendering and natural language processing. The edge processing system 100 can function as a field AR rendering and streaming server, facilitating applications for maintenance, asset schematics/cutaways, and facilitating remote troubleshooting sessions between the field worker and an office-based expert. Additionally, the edge processing system 100 can serve as a unified source for data consumption through an AR application, replacing the individual human-machine interfaces for each component or sensor on the wellsite and integrating it into a single AR application to expedite review.

Another advantage of the presently described techniques is that the edge processing system 100 can monitor activities at the energy industry operation site to ensure proper invoicing. For example, the edge processing system 100 can use computer vision to determine the timestamps of trucks entering and leaving the energy industry operation site. This provides a record of transactions and services occurring on the energy industry operation site that can be audited by comparing against invoicing data (also referred to as performance data).

It is understood that the present disclosure is capable of being implemented in conjunction with any other type of computing environment now known or later developed. For example, FIG. 7 depicts a block diagram of a processing system 700 for implementing the techniques described herein. In examples, processing system 700 has one or more central processing units (processors) 721a, 721b, 721c, etc. (collectively or generically referred to as processor(s) 721 and/or as processing device(s)). In aspects of the present disclosure, each processor 721 can include a reduced instruction set computer (RISC) microprocessor. Processors 721 are coupled to system memory (e.g., random access memory (RAM) 724) and various other components via a system bus 733. Read only memory (ROM) 722 is coupled to system bus 733 and may include a basic input/output system (BIOS), which controls certain basic functions of processing system 700.

Further depicted are an input/output (I/O) adapter 727 and a network adapter 726 (e.g., the network adapter 317 of FIG. 3) coupled to system bus 733. I/O adapter 727 may be a small computer system interface (SCSI) adapter that communicates with a hard disk 723 and/or a storage device 725 (e.g., the storage device 328 of FIG. 3) or any other similar component. I/O adapter 727, hard disk 723, and storage device 725 are collectively referred to herein as mass storage 734. Operating system 740 for execution on processing system 700 may be stored in mass storage 734. The network adapter 726 interconnects system bus 733 with an outside network 736 enabling processing system 700 to communicate with other such systems.

A display (e.g., a display monitor) 735 is connected to system bus 733 by display adapter 732, which may include a graphics adapter to improve the performance of graphics intensive applications and a video controller. In one aspect of the present disclosure, adapters 726, 727, and/or 732 may be connected to one or more I/O busses that are connected to system bus 733 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 733 via user interface adapter 728 (e.g., the user interface adapter 316 of FIG. 3) and display adapter 732 (e.g., the display adapter 324 of FIG. 3). A keyboard 729, mouse 730, and speaker 731 (e.g., the speaker 320) may be interconnected to system bus 733 via user interface adapter 728, which may include, for example, a Super I/O chip integrating multiple device adapters into a single integrated circuit.

In some aspects of the present disclosure, processing system 700 includes a graphics processing unit 737. Graphics processing unit 737 is a specialized electronic circuit designed to manipulate and alter memory to accelerate the creation of images in a frame buffer intended for output to a display. In general, graphics processing unit 737 is very efficient at manipulating computer graphics and image processing, and has a highly parallel structure that makes it more effective than general-purpose CPUs for algorithms where processing of large blocks of data is done in parallel.

Thus, as configured herein, processing system 700 includes processing capability in the form of processors 721, storage capability including system memory (e.g., RAM 724), and mass storage 734, input means such as keyboard 729 and mouse 730, and output capability including speaker 731 and display 735. In some aspects of the present disclosure, a portion of system memory (e.g., RAM 724) and mass storage 734 collectively store an operating system to coordinate the functions of the various components shown in processing system 700.

Set forth below are some embodiments of the foregoing disclosure:

Embodiment 1: A system comprising: an energy industry operation component; and a processing system associated with the energy industry operation component, the processing system comprising an accelerator and being configured to perform at least one of image segmentation and vision analysis for authenticated lockout, image segmentation and vision analysis for performance audit, or augmented reality rendering and streaming.

Embodiment 2: The system of any prior embodiment further comprising a camera to generate an image and transmit the image to the processing system, wherein the processing system performs at least one of the image segmentation and vision analysis for authenticated lockout or the image segmentation and vision analysis for performance audit based at least in part on the image received from the camera.

Embodiment 3: The system of any prior embodiment, wherein performing the image segmentation and vision analysis for authenticated lockout comprises authenticating a user against a database of known users using the image, wherein the user is granted access to the energy industry operation component responsive to successfully authenticating a user, and wherein the user is not granted access to the energy industry operation component responsive to unsuccessfully authenticating the user.

Embodiment 4: The system of any prior embodiment, wherein performing the image segmentation and vision analysis comprises drawing a bounding box around an object of interest in the image and categorizing a type of the object of interest.

Embodiment 5: The system of any prior embodiment, wherein performing the image segmentation and vision analysis for authenticated lockout comprises analyzing the image to determine whether a user is equipped with personal protective equipment, wherein the user is granted access to the energy industry operation component responsive to determining that the user is equipped with personal protective equipment, and wherein the user is not granted access to the energy industry operation component responsive to determining that the user is not equipped with personal protective equipment.

Embodiment 6: The system of any prior embodiment, wherein performing the image segmentation and vision analysis for performance audit further comprises: associating, by the processing system, a time stamp of a service being performed at the energy industry operation, the time stamp being determined based at least in part on the image; and performing the performance audit by comparing the time stamp to performance data to verify that the service was performed.

Embodiment 7: The system of any prior embodiment, wherein the performance data comprises invoice data, health and safety environment data, human resources planning data, and service planning and safety data.

Embodiment 8: The system of any prior embodiment, wherein the energy industry operation component is a variable speed drive.

Embodiment 9: The system of any prior embodiment, wherein the processing system is further configured to perform natural language processing on an input received from a user of the processing system, to generate a command based on the natural language processing, and to cause the energy industry operation component to perform an action based at least in part on the command.

Embodiment 10: The system of any prior embodiment, wherein the accelerator is a graphics processing unit.

Embodiment 11: A method comprising: receiving, by a processing system comprising an accelerator, an image from a camera, the camera capturing the image at an energy industry operation site; performing, by the processing system, image segmentation and vision analysis for authenticated lockout based at least in part on the image; fetermining, by the processing system, whether an authentication lockout criterion is satisfied; and, responsive to determining that the authentication lockout criterion is not satisfied, implementing, by the processing system, a lockout procedure on an energy industry operation component at the energy industry operation site.

Embodiment 12: The method of any prior embodiment further comprising, responsive to determining that the authentication lockout criterion is satisfied, granting, by the processing system, access to an energy industry operation component at the energy industry operation site, and initiating a shutdown procedure to reduce an energy state of the energy industry operation component from a higher energy state to a lower energy state.

Embodiment 13: A method comprising: receiving, by a processing system comprising an accelerator, an image from a camera, the camera capturing the image at an energy industry operation site; performing, by the processing system, image segmentation and vision analysis for authenticated performance audit based at least in part on the image to associate a time stamp with a service performed at the energy industry operation site; determining, by the processing system, whether the time stamp associated with the service corresponds to performance data; and, responsive to determining that the time stamp associated with the service does not correspond to the performance data, implementing, by the processing system, a corrective action to correct the performance data.

Embodiment 14: A method comprising: storing an augmented reality package in a memory of a processing system associated with an energy industry operation component at an energy industry operation site, the processing system comprising an accelerator; receiving, by the processing system, a request for the augmented reality package from a user device associated with a user; rendering, by accelerator of the processing system, the augmented reality package; and streaming, by the processing system, the rendered augmented reality package to the user device associated with the user.

Embodiment 15: The method of any prior embodiment, wherein the user device is a first user device, and wherein the user is a first user and is located at the energy industry operation site, the method further comprising streaming, by the processing system, the rendered augmented reality package to a second user device associated with a second user being remote from the energy industry operation site while streaming the rendered augmented reality package to the first user device associated with the first user.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “coupled” relates to a first component being coupled to a second component either directly or indirectly via an intermediary component. The term “configured” relates to one or more structural limitations of a device that are required for the device to perform the function or operation for which the device is configured.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While one or more embodiments have been shown and described, modifications and substitutions may be made thereto without departing from the spirit and scope of the invention. Accordingly, it is to be understood that the present invention has been described by way of illustrations and not limitation.

It will be recognized that the components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system comprising:
an energy industry operation component; and
a processing system associated with the energy industry operation component, the processing system comprising an accelerator and being configured to perform at least one of image segmentation and vision analysis for authenticated lockout, image segmentation and vision analysis for performance audit, or augmented reality rendering and streaming.

2. The system of claim 1, further comprising:
a camera to generate an image and transmit the image to the processing system,
wherein the processing system performs at least one of the image segmentation and vision analysis for authenticated lockout or the image segmentation and vision analysis for performance audit based at least in part on the image received from the camera.

3. The system of claim 2, wherein performing the image segmentation and vision analysis for authenticated lockout comprises authenticating a user against a database of known users using the image, wherein the user is granted access to the energy industry operation component responsive to successfully authenticating a user, and wherein the user is not granted access to the energy industry operation component responsive to unsuccessfully authenticating the user.

4. The system of claim 2, wherein performing the image segmentation and vision analysis comprises drawing a bounding box around an object of interest in the image and categorizing a type of the object of interest.

5. The system of claim 2, wherein performing the image segmentation and vision analysis for authenticated lockout comprises analyzing the image to determine whether a user is equipped with personal protective equipment, wherein the user is granted access to the energy industry operation component responsive to determining that the user is equipped with personal protective equipment, and wherein the user is not granted access to the energy industry operation component responsive to determining that the user is not equipped with personal protective equipment.

6. The system of claim 2, wherein performing the image segmentation and vision analysis for performance audit further comprises:
associating, by the processing system, a time stamp of a service being performed at the energy industry operation, the time stamp being determined based at least in part on the image; and
performing the performance audit by comparing the time stamp to performance data to verify that the service was performed.

7. The system of claim 6, wherein the performance data comprises invoice data, health and safety environment data, human resources planning data, and service planning and safety data.

8. The system of claim 1, wherein the energy industry operation component is a variable speed drive.

9. The system of claim 1, wherein the processing system is further configured to perform natural language processing on an input received from a user of the processing system, to generate a command based on the natural language processing, and to cause the energy industry operation component to perform an action based at least in part on the command.

10. The system of claim 1, wherein the accelerator is a graphics processing unit.

11. A method comprising:
receiving, by a processing system comprising an accelerator, an image from a camera, the camera capturing the image at an energy industry operation site;
performing, by the processing system, image segmentation and vision analysis for authenticated lockout based at least in part on the image;
determining, by the processing system, whether an authentication lockout criterion is satisfied; and
responsive to determining that the authentication lockout criterion is not satisfied, implementing, by the processing system, a lockout procedure on an energy industry operation component at the energy industry operation site.

12. The method of claim 11, further comprising:
responsive to determining that the authentication lockout criterion is satisfied, granting, by the processing system, access to an energy industry operation component at the energy industry operation site, and initiating a shutdown procedure to reduce an energy state of the energy industry operation component from a higher energy state to a lower energy state.

13. A method comprising:
receiving, by a processing system comprising an accelerator, an image from a camera, the camera capturing the image at an energy industry operation site;
performing, by the processing system, image segmentation and vision analysis for authenticated performance audit based at least in part on the image to associate a time stamp with a service performed at the energy industry operation site;
determining, by the processing system, whether the time stamp associated with the service corresponds to performance data; and
responsive to determining that the time stamp associated with the service does not correspond to the performance data, implementing, by the processing system, a corrective action to correct the performance data.

14. A method comprising:
storing an augmented reality package in a memory of a processing system associated with an energy industry operation component at an energy industry operation site, the processing system comprising an accelerator;
receiving, by the processing system, a request for the augmented reality package from a user device associated with a user;
rendering, by accelerator of the processing system, the augmented reality package; and
streaming, by the processing system, the rendered augmented reality package to the user device associated with the user.

15. The method of claim 14, wherein the user device is a first user device, and wherein the user is a first user and is located at the energy industry operation site, the method further comprising:
streaming, by the processing system, the rendered augmented reality package to a second user device associated with a second user being remote from the energy industry operation site while streaming the rendered augmented reality package to the first user device associated with the first user.
